(19) United States
(12) Patent Application Publication
(10) Pub. No.: US 2009/0006651 A1
(43) Pub. Date: Jan. 1, 2009

(54) Document Delivery System and Method There Of

(76) Inventor: Jong Chul Kim, Seoul (KR)

Correspondence Address: CHRISTIE, PARKER & HALE, LLP, PO BOX 7068, PASADENA, CA, 91109-7068, US

(21) Appl. No.: 12/224,230

(22) PCT Filed: Feb. 27, 2006
(86) PCT No.: PCT/KR2006/000680

§ 371 Date: Aug. 20, 2008

(51) Int. Cl. G06F 15/16

(52) U.S. Cl. 709/246

(57) ABSTRACT

A mobile document transfer system using a document format with a font data and a method thereof are disclosed. More concretely, when the document made by a computer user terminal is transmitted to a receiver mobile communication terminal through an internet, a document format file having the font data capable of inquiring in the shape of the font equally with the original document is converted, a SMS message or an URL of the corresponding web page having the URL address of a document storage server storing the corresponding document is transmitted to the receiver mobile communication terminal, and the document format file stored in the corresponding URL is transmitted to the receiver mobile communication terminal according to the request of the receiver mobile communication terminal, whereby the corresponding document format file can be viewed equally with the original document.

### TECHNICAL FIELD

The present invention relates to a mobile document transfer system using a document format with a font data and a method thereof, and more particularly to a mobile document transfer system using a document format with a font data and a method thereof in that, when the document made by a computer user terminal is transmitted to a receiver mobile communication terminal through an internet, a document format file having the font data capable of inquiring in the shape of the font equally with the original document is converted, a SMS message or an URL of the corresponding web page having the URL address of a document storage server storing the corresponding document is transmitted to the receiver mobile communication terminal, and the document format file stored in the corresponding URL is transmitted to the receiver mobile communication terminal according to the request of the receiver mobile communication terminal, whereby the corresponding document format file can be viewed equally with the original document.

### BACKGROUND ART

Recently, a demand capable of inquiring and utilizing a document under various surroundings has been increased according to the issue of “Ubiquitous”. Also, a cell phone with a file viewer capable of viewing the document in a mobile communication terminal has been released.

However, in order to inquire the document in the mobile communication terminal at present, it is necessary to connect a computer terminal with the mobile communication terminal through a connecting cable such as an USB port and like and transmit the data of the computer terminal to the mobile communication terminal. Accordingly, there are restrictive and inconvenient in use. That is, since the mobile communication terminal has a small capacity in memory, there is a limit in memory capacity that the document itself of the computer terminal cannot be transmitted to the mobile communication terminal through an internet. Also, an application capable of inquiring the document is not installed in all mobile communication terminals.

Also, as though the file viewer is installed in the mobile communication terminals, the document can be viewed through the mobile communication terminal only in case of connecting the computer terminal with the mobile communication terminal through the connecting cable. The file viewer of the mobile communication terminals can be applied to only MS-office document, not all document formats.

Moreover, since the mobile communication terminal does not have all kinds of fonts existed in PC environments, it is impossible to view in the shape of the font equally with the original document.

Therefore, a mobile document transfer system capable of improving the document inquiry environment in the restricted mobile communication terminal and transmitting and receiving the desirous document anytime and anywhere without correlation to the corresponding document format file has been required.

### DISCLOSURE OF INVENTION

### Technical Problem

Accordingly, the present invention has been made to solve the above-mentioned problems occurring in the prior art, and an object of the present invention is to provide a mobile document transfer system using a document format with a font data and a method thereof, in that a document written by various document writing program is converted into a document format file having a font data capable of viewing equally with an original document in a receiver mobile communication terminal and an URL information having a corresponding document format file is transmitted to the receiver mobile communication terminal, so that it can check out the corresponding document in the receiver mobile communication terminal having a restricted resource by means of the converted document file and the document viewer of the receiver mobile communication terminal without installing various document programs.

### Technical Solution

To accomplish the object, the present invention provides a mobile document transfer system using a document format with a font data comprising a user terminal for writing and saving a document with various document writing programs and connecting to a document receiving server through an internet; the document receiving server for receiving an original document made by the user terminal and a receiver information; a document format conversion server for receiving the document and converting the document into a document format file having a font capable of viewing the document format file in the receiver mobile communication terminal; a document storage server for assigning the file converted by the document format conversion server to a physical location of an URL (uniform resource locator) and saving it; a message transmission server for generating a SMS message or a message of a WAP (wireless application protocol) PUSH type having the URL and transmitting it to the receiver mobile communication terminal; a viewer downloading server for perceiving an existence or nonexistence of any viewer capable of viewing the document format file in the receiver mobile communication terminal and downloading it thereto; and the receiver mobile communication terminal for receiving the message having the URL from the message transmission server, connecting to the URL in order to receive the corresponding document file and display it to a receiver.

Preferably, the document receiving server receives the document (original document) from the user terminal to be converted and a country code of the receiver mobile communication terminal and so on.

Preferably, the document storage server saves the document by means of a network capable of connecting the receiver mobile communication terminal thereto through a WAP protocol.

Preferably, when the converted document format file having the font is received first, it checks out the corresponding document viewer prior to download the document from the document storage server and if not, it automatically downloads the corresponding document viewer from the viewer downloading server.

Preferably, when the converted document format file having the font is received, it checks out the existence or nonexistence of the document viewer in the receiver mobile communication terminal and it does not downloads the corresponding document viewer from the viewer downloading server in case of having it therein.

Preferably, the converted document format file has the font used in the document (original document) during the conversion in the document format conversion server, so that it can view the format file equally with the document (original document) in spite of the nonexistence of the same font in the receiver mobile communication terminal.

To accomplish the object, the present invention provides a transferring method of a mobile document using a document format with a font data, comprising the steps of connecting to a document receiving server through an internet and transmitting a document made by various document writing programs of a user terminal and an information on a receiver mobile communication terminal to the document receiving server; transmitting the document made by the user terminal to a document format conversion server in order to request a conversion of the corresponding document; converting the document into a document format file having a font capable of viewing the document format file equally with an original document in the receiver mobile communication terminal; assigning the file converted by the document format conversion server to a physical location of an URL (uniform resource locator) and saving it; transmitting a SMS message or a message of a WAP (wireless application protocol) PUSH type having the URL to the receiver mobile communication terminal; checking the received message and an existence or nonexistence of corresponding document viewer in the receiver mobile communication terminal during the connection thereof; automatically downloading the corresponding document viewer from a viewer downloading server in a case that the corresponding document viewer is not existed therein; downloading the corresponding document file through the URL; and displaying the received document file through the document viewer.

Preferably, in the message transmission step, during the documents transmission between countries, it makes out the country code transmitted through the document receiving server, searches the document receiving server of the corresponding country through the internet network, and transmits the original document and the number of the receiver mobile communication terminal to the document receiving server of the corresponding country through the network.

### ADVANTAGEOUS EFFECTS

As can be seen from the foregoing, in the mobile document transfer system using the document format with the font data and the method thereof according to the present invention, there are effects, in that the document written by various document writing program is converted into the document format file having the font data and the URL information having the corresponding document format file is transmitted to the receiver mobile communication terminal, so that it can check out the corresponding document in the receiver mobile communication terminal having the restricted resource by means of the document viewer capable of viewing the corresponding document without installing various document programs, whereby transmitting and receiving the desirous document to the user anytime and anywhere for its convenience.

### BRIEF DESCRIPTION OF THE DRAWINGS

The above as well as the other objects, features and advantages of the present invention will be more apparent from the following detailed description taken in conjunction with the accompanying drawings, in which:

FIG. 1 is a block diagram illustrating a mobile document transfer system using a document format with a font data according to one embodiment of the present invention;

FIG. 2 is a flow chart illustrating a transferring method of a mobile document using a document format with a font data according to one embodiment of the present invention; and

FIG. 3 is a block diagram illustrating a mobile document transfer system using a document format with a font data during the documents transmission between countries according to another embodiment of the present invention.

### BEST MODE FOR CARRYING OUT THE INVENTION

A preferred embodiment of the invention will be described in detail below with reference to the accompanying drawings.

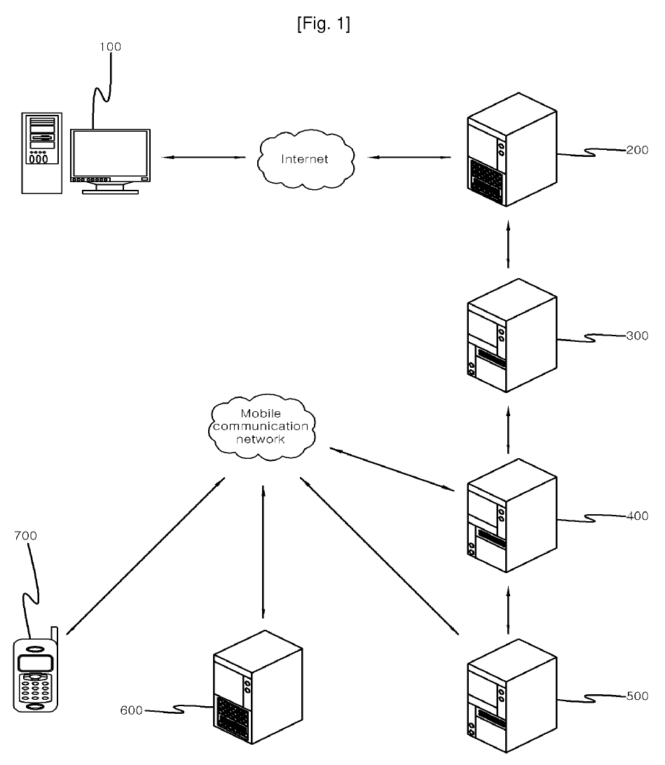

FIG. 1 is a block diagram illustrating a mobile document transfer system using a document format with a font data according to one embodiment of the present invention.

As shown in FIG. 1, the mobile document transfer system using a document format with a font data includes a user terminal 100 for writing and saving a document with various document writing programs and connecting to a document receiving server 200 through an internet; the document receiving server 200 for receiving an original document made by the user terminal 100 and a receiver information; a document format conversion server 300 for receiving the document and converting the document into a document format file having a font capable of viewing the document format file in the receiver mobile communication terminal 700; a document storage server 400 for assigning the file converted by the document format conversion server 300 to a physical location of an URL (uniform resource locator) and saving it; a message transmission server 500 for generating a SMS message or a message of a WAP (wireless application protocol) PUSH type having the URL and transmitting it to the receiver mobile communication terminal 700; a viewer downloading server 600 for perceiving an existence or nonexistence of any viewer capable of viewing the document format file in the receiver mobile communication terminal 700 and downloading it thereto; and the receiver mobile communication terminal 700 for receiving the message having the URL from the message transmission server 500, connecting to the URL in order to receive the corresponding document file and display it to a receiver.

Here, the document receiving server 200 receives the document (original document) from the user terminal 100 to be converted and a country code of the receiver mobile communication terminal 700 and so on.

Also, the document storage server 400 saves the document by means of a network capable of connecting the receiver mobile communication terminal 700 thereto through a WAP protocol.

Moreover, when the converted document format file having the font is received first, it checks out the corresponding document viewer prior to download the document from the document storage server 400 and if not, it automatically downloads the corresponding document viewer from the viewer downloading server 600.

Furthermore, when the converted document format file having the font is received, it checks out the existence or nonexistence of the document viewer in the receiver mobile communication terminal 700 and it does not downloads the corresponding document viewer from the viewer downloading server 600 in case of having it therein.

Also, the converted document format file has the font used in the document (original document) during the conversion in the document format conversion server 300, so that it can view the format file equally with the document (original document) in spite of the nonexistence of the same font in the receiver mobile communication terminal 700.

Accordingly, the electronic document made by the user terminal is transmitted to the receiver mobile communication terminal 700 in the form of the SMS message or the WAP PUSH message having the URL through a mobile service site, so that the receiver can view it through the downloaded document viewer.

The document viewer mentioned in the present invention should be existed in each receiver mobile communication terminal 700. If not, the document viewer is downloaded from the viewer downloading server 600 when the converted document format file is received first and it checks out the corresponding document viewer. Here, the downloading process of the document viewer is omitted in a case that the document viewer is already existed in the receiver mobile communication terminal 700.

Also, the document written by various document writing programs is converted into the document format file having the font and only URL information, which is an index of the converted file, is transmitted to the receiver mobile communication terminal 700. Accordingly, there is a merit in that the document format file and the document viewer can be quickly downloaded in the receiver mobile communication terminal 700 having a restricted source.

Furthermore, in the document format file having the font of the general electronic document, the converted speed and inquiry speed thereof are fast. Since the converted file, which is converted through an image duplication elimination using an image compression, a document code information compression, and a pattern matching, is small in size in comparison with the original document, it can be quickly and conveniently used in the receiver mobile communication terminal 700 having the restricted transmission and storage.

Moreover, the document receiving server 200 serves to receive the document (original document) from the user terminal 100, the number of the receiver mobile communication terminal 700 and the country code of the receiver mobile communication terminal 700 and so on.

The document format conversion server 300 serves to receive the document made by the user terminal 100 and automatically convert the document into the document format file having the font. That is, the document format conversion server 300 serves to convert the original document into the document format file having the font capable of viewing it equally with the original document in the receiver mobile communication terminal 700.

The document storage server 400 serves to save the converted file converted through the document format conversion server 300. That is, the document storage server 400 saves the document by means of the network capable of connecting the receiver mobile communication terminal 700 thereto through the standard WAP protocol.

The message transmission server 500 serves to transmit the message to the receiver mobile communication terminal 700. That is, the message transmission server 500 transmits the location of the document stored in the document storage server 400 to the receiver mobile communication terminal 700 in the form of the SMS message having the URL or the WAP (wireless application protocol) PUSH message for delivering the URL.

When the converted document format file is received in the receiver mobile communication terminal 700, it checks out whether the corresponding document viewer is existed or not therein and then, it does not download the corresponding document viewer from the viewer downloading server 600 in case of having it therein.

That is, the document format file having the font according to the present invention and the viewer having the document can be widely applied, unlike the conventional viewer for supporting only localized document writing program.

The message transmission server 500 generates the SMS message or the message of the WAP (wireless application protocol) PUSH type having the URL of the document storage server 400 for providing the stored document and transmits it to the receiver mobile communication terminal 700.

The viewer downloading server 600 serves to check out as to whether the document viewer is existed in the receiver mobile communication terminal 700 or not during connecting with the receiver mobile communication terminal 700. Here, it does not download the corresponding document viewer from the viewer downloading server 600 in case of having it therein. At this time, where the corresponding document viewer is once down loaded and then, the document format file having the font is received, it is unnecessary to download the document viewer again.

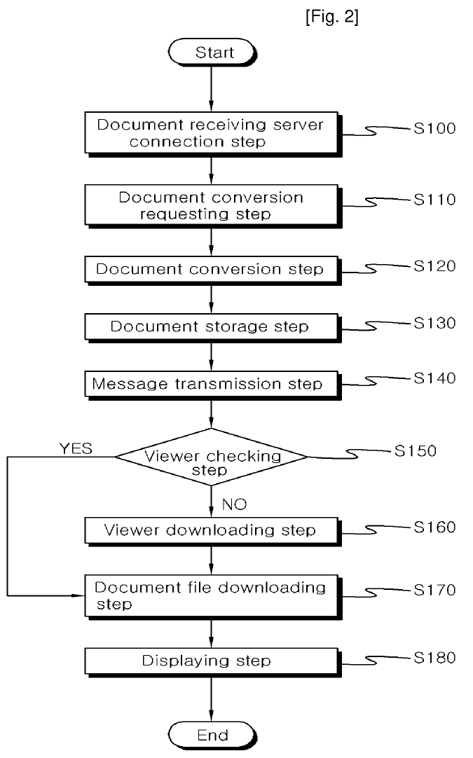

FIG. 2 is a flow chart illustrating a transferring method of a mobile document using a document format with a font data according to one embodiment of the present invention.

As shown in FIG. 2, the transferring method of a mobile document using a document format with a font data according to the present invention includes a document receiving server connection step S100 for connecting to a document receiving server 200 through an internet and transmitting a document made by various document writing program of a user terminal 100 and an information on a receiver mobile communication terminal 700 to the document receiving server 200; a document conversion requesting step S110 for transmitting the document made by the user terminal 100 to a document format conversion server 300 in order to request a conversion of the corresponding document; a document conversion step S120 for converting the document into a document format file having a font capable of viewing the document format file equally with an original document in the receiver mobile communication terminal 700; a document storage step S130 for assigning the file converted by the document format conversion server 300 to a physical location of an URL (uniform resource locator) and saving it; a message transmission step S140 for transmitting a SMS message or a message of a WAP (wireless application protocol) PUSH type having the URL to the receiver mobile communication terminal 700; a viewer checking step S150 for checking the received message and an existence or nonexistence of corresponding document viewer in the receiver mobile communication terminal 700 during the connection thereof; a viewer downloading step 160 for automatically downloading the corresponding document viewer from a viewer downloading server 600 in a case that the corresponding document viewer is not existed therein; a document file downloading step 170 for downloading the corresponding document file through the URL; and a displaying step S180 for displaying the received document file through the document viewer.

In the meantime, in the message transmission step S140, during the documents transmission between countries, it makes out the country code transmitted through the document receiving server 200, searches the document receiving server 200 of the corresponding country through the internet network, and transmits the original document and the number of the receiver mobile communication terminal 700 to the document receiving server 200 of the corresponding country through the network.

More concretely, the user writes the electronic document through various document writing program of a user terminal 100 and connects to the document receiving server 200 through the internet (S100). Then, the document receiving server 200 receives the document made by the user terminal 100 and asks the document format conversion server 300 to convert the document into a document format file having the font capable of viewing the document format file equally with the original document in the receiver mobile communication terminal 700 (S110). Thereafter, the document is converted into the document format file capable of viewing the document format file equally with the original document in the receiver mobile communication terminal 700 (S120) and the converted document file is assigned to the physical location of the URL (uniform resource locator) and is stored in the document storage server 400 (S130). Here, the SMS message or the WAP (wireless application protocol) PUSH message having the URL indicating the stored site is transmitted to the receiver mobile communication terminal 700 (S140).

Continuously, the received message and the existence or nonexistence of corresponding document viewer are checked in the receiver mobile communication terminal 700 during the connection thereof (S150) and then, the corresponding document viewer is automatically downloaded from the viewer downloading server 600 in a case that the corresponding document viewer is not existed therein (S160). Finally, the corresponding document file is downloaded through the URL (S170) and the corresponding document file is displayed through the document viewer to the receiver mobile communication terminal 700 to check it (S180).

In the meantime, in the message transmission step S140 as described above, during the documents transmission between countries, it makes out the country code transmitted through the document receiving server 200, searches the document receiving server 200 of the corresponding country through the internet network, and transmits the original document and the number of the receiver mobile communication terminal 700 to the document receiving server 200 of the corresponding country through the network.

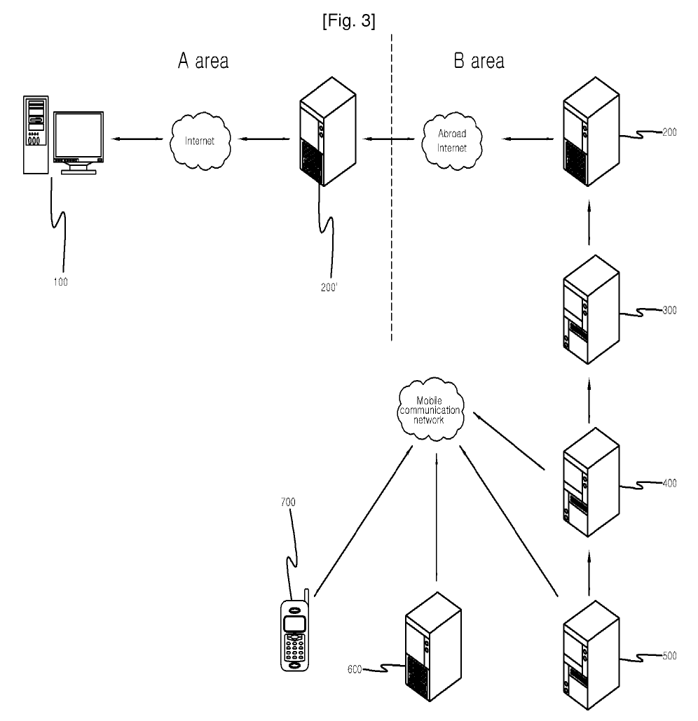

FIG. 3 is a block diagram illustrating a mobile document transfer system using a document format with a font data during the documents transmission between countries according to another embodiment of the present invention.

As shown in FIG. 3, the user writes the electronic document through various document writing program of a user terminal 100 and connects to the document receiving server 200 through the internet, so that the information (cellular phone number or country code and so on) on the receiver mobile communication terminal 700 is transmitted to the document receiving server 200.

In a case that the country code is different from that of the corresponding country in the document receiving server 200, it searches the document receiving server 200 of the corresponding country through the internet network and transmits the original document and the number information of the receiver mobile communication terminal 700 to the document receiving server 200 of the corresponding country searched through the network. Subsequent processes are equally performed through the document receiving server 200 of the corresponding country, the SMS message or the WAP PUSH message, the viewer downloading server 600, the receiver mobile communication terminal 700 and so on as stated above.

Also, the document format file having the font capable of viewing the document format file equally with the original document may use well-known techniques such as a PDF technique by an Adobe Systems Corporation resident in USA, a CSD technique by a Dream To Reality Co., Ltd. resident in Korea or a RGO technique by a Cerience Corporation resident in USA and so on. Here, since the document format techniques are already well-known in public, the description on the related techniques is omitted here.

Moreover, the document receiving server 200 can further include a country code discrimination portion for discriminating the country code inputted by the user terminal during the documents transmission between countries.

Furthermore, during the documents transmission between countries, the user can receive and check out the document through the receiver mobile communication terminal of corresponding country as well as another country by using the internet.

### INDUSTRIAL APPLICABILITY

As can be seen from the foregoing, in the mobile document transfer system using the document format with the font data and the method thereof, when the document made by a computer user terminal is transmitted to the receiver mobile communication terminal through the internet, the document format file having the font data capable of inquiring in the shape of the font equally with the original document is converted, the SMS message or the URL of the corresponding web page having the URL address of the document storage server storing the corresponding document is transmitted to the receiver mobile communication terminal, and the document format file stored in the corresponding URL is transmitted to the receiver mobile communication terminal according to the request of the receiver mobile communication terminal, whereby the corresponding document can be viewed equally with the original document.

While this invention has been described in connection with what are presently considered to be the most practical and preferred embodiments, it is to be understood that the invention is not limited to the disclosed embodiments and the drawings, but, on the contrary, it is intended to cover various modifications and variations within the spirit and scope of the appended claims.

1. A mobile document transfer system for transferring a document having a document format with a font data comprising:
one or more servers, each configured with a processor and a memory device operably coupled to the processor storing program instructions therein, the one or more servers operable to execute one or more of the program instructions via the corresponding processor, the program instructions including:
receiving over the data communications network a document generated by a user terminal via one of various document generating programs and information of a receiver mobile communication terminal to receive the generated document;
automatically converting, without user intervention, the received document into a converted file configured to provide for viewing one or more original fonts used in the generated document;
storing the converted file in a location identified by a document link;
automatically generating, without user intervention, a message including the document link, and transmitting the message to the receiver mobile communication terminal;
determining whether the receiver mobile communication terminal includes a document viewer configured to display the converted file, and downloading the document viewer in response to the determination;
receiver receiving from the receiver mobile communication terminal actuation of the document link; and
transmitting the converted file to the receiver mobile communication terminal for display of the file with the original fonts via the document viewer in response to the actuation of the document link.

2. The mobile document transfer system as claimed in claim 1, wherein the program instructions for receiving the document generated by the user terminal further include receiving a country code of the receiver mobile communication terminal.

3. The mobile document transfer system as claimed in claim 1, wherein the program instructions further include connecting with the receiver mobile communication terminal via a wireless application protocol.

4. The mobile document transfer system as claimed in claim 1, wherein the program instructions further include automatically downloading the document viewer in response to a determination that the receiver mobile communication terminal does not include the document viewer.

5. The mobile document transfer system as claimed in claim 1, wherein the program instructions further include refraining from downloading the document viewer in response to a determination that the receiver mobile communication terminal includes the document viewer.

6. The mobile document transfer system as claimed in claim 1, wherein the display of the converted file via the document viewer includes the display of the one or more original fonts in the converted file as it would display in the document despite nonexistence of the one or more original fonts in the receiver mobile communication terminal.

7. A method for transferring a document having a document format with font data to a mobile communication terminal, the method comprising:
receiving a document generated by a user terminal via one of various document generating programs and information on a receiver mobile communication terminal to receive the generated document;
automatically converting, without user intervention, the received document into a converted file configured to provide for viewing one or more original fonts used in the generated document as it would be viewed in the generated document;
storing the converted file in a location identified by a document link;
transmitting a message including the document link to the receiver mobile communication terminal;
determining whether the receiver mobile communication terminal includes a document viewer configured to display the converted file;
automatically downloading the document viewer in response to a determination that the receiver mobile communication terminal does not include the document viewer;
receiving from the mobile communication terminal actuation of the document link; and
transmitting the converted file to the receiver mobile communication terminal for display of the file with the original fonts via the document viewer in response to the actuation of the document link.

8. The method as claimed in claim 7, wherein the document is transmitted between countries, the method further comprising identifying by a first server on a data communications network a country code of the receiver mobile communication terminal, identifying a second server on the data communications network corresponding to the identified country code, and transmitting by the first server the document and a number identifying the receiver mobile communication terminal to the identified second server over the data communications network.

9. The mobile document transfer system of claim 1, wherein the document link is a uniform resource locator.

10. The mobile document transfer system of claim 1, wherein the receiver mobile communication terminal is a mobile phone.

11. The mobile document transfer system of claim 10, wherein the message is a text message generated via a text messaging protocol.

12. The mobile document transfer system of claim 10, wherein the message is a message accessible via a wireless application protocol.

13. The method of claim 7, wherein the document link is a uniform resource locator.

14. The method of claim 7, wherein the receiver mobile communication terminal is a mobile phone.

15. The method of claim 14, wherein the message is a text message generated via a text messaging protocol.

16. The method of claim 14, wherein the message is a message accessible via a wireless application protocol.
